(19) United States
(12) Patent Application Publication
(10) Pub. No.: US 2008/0123348 A1
(43) Pub. Date: May 29, 2008

(54) Magnetic actuator and magnetic light-shielding apparatus

(75) Inventors: Sean Chang, Taoyuan Hsien (TW); Chii-How Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/980,376

(22) Filed: Oct. 31, 2007

(30) Foreign Application Priority Data
Nov. 23, 2006 (TW) 095143378

(51) Int. Cl. H01F 7/08; F21V 17/02

(52) U.S. Cl. 362/321; 335/222

(57) ABSTRACT

A magnetic light-shielding apparatus includes a body, a light-shielding element and a magnetic actuator. The body has a light-penetrating portion, and one end of the light-shielding element is disposed pivotally on the body to form a rotation center. The light-shielding element corresponding to the light-penetrating portion rotates with respect to the rotation center. The magnetic actuator has a magnetic element, a magnetically conducting element and a coil. The magnetically conducting element is disposed with respect to the magnetic element. The coil is disposed at the other end of the light-shielding element and surrounds the magnetically conducting element.

### CROSS REFERENCE TO RELATED APPLICATIONS

This Non-provisional application claims priority under 35 U.S.C. §119(a) on Patent Application No(s). 095143378 filed in Taiwan, Republic of China on Nov. 23, 2006, the entire contents of which are hereby incorporated by reference.

### BACKGROUND OF THE INVENTION

1. Field of Invention

The invention relates to an actuator structure and a light-shielding apparatus. In particular, the invention relates to a magnetic actuator and magnetic light-shielding apparatus.

2. Related Art

There are various kinds of optoelectronic products, such as digital still cameras (DSC), digital video (DV) and projector, that emit light and the emitted light is processed to form an image. To control the incoming optical flux, the optoelectronic products usually use a magnetic light-shielding apparatus as an iris diaphragm. The iris diaphragm is driven by a magnetic actuator that controls a light-shielding apparatus, thereby controlling the incoming optical flux.

As shown in FIG. 1, a conventional magnetic actuator 1 includes a rotating arm 11, a coil 12, four magnets 13a to 13d, and two yokes 14, 15. One end 111 of the rotating arm 11 has a rotation center RC. The other end is connected to the coil 12. The magnets 13a, 13b are connected to each other and disposed above the coil 12. The magnets 13c, 13d are connected to each other and disposed under the coil 12. The polarities of the magnets 13a to 13d are N, S, S, N (labeled after the numerals) in order. Each of the yokes 14, 15 has a U shape and is connected to the other. The magnets 13a to 13d and the coil 12 are disposed between the yokes 14, 15. Therefore, the magnetic actuator 1 forms two closed magnetic loops. One of them goes in sequence the magnet 13a, the yoke 14, the yoke 15 and the magnet 13c, and returns to the magnet 13a. The other magnetic loop goes in sequence the magnet 13b, the yoke 14, the yoke 15, the magnet 13d, and returns to the magnet 13b.

As shown in FIG. 2, when an electrical current flows through the coil 12 (electrical current i as indicated by the arrow), it interacts with the passing magnetic lines. For a first side 121 of the coil 12, the magnetic line B points out of the paper (represented by “•”). For a second side 122 of the coil 12, the magnetic line B points into the paper (represented by x). According to Fleming's right-hand rule, both the first side 121 and the second side 122 of the coil 12 produce a Lorentz force to rotate the rotating arm 11 and the coil 12 with respect to the rotation center RC (in the direction shown in FIG. 2). In addition, the coil 12 is connected to a light-shielding element (not shown) to form an iris diaphragm. As the coil 12 rotates, the light-shielding element is driven to rotate, controlling the incoming optical flux.

However, the magnetic actuator 1 has to use four magnets 13a to 13d and thus costs more. Since the yokes 14, 15 are thicker, the casting cost is also higher. In addition, the size of the magnetic actuator 1 is too large for miniaturization, making the products less competitive. Moreover, the coil 12 is disposed between the rotation center RC and the light-shielding element. This renders the coil 12 a shorter lever arm than the light-shielding element. Therefore, the coil 12 requires larger power consumption in order to rotate the light-shielding element. This lowers the efficiency of the magnetic actuator 1.

Therefore, it is an important subject to provide a magnetic actuator and a magnetic shielding apparatus that has a lower cost and more compact size. This helps reduce the power consumption of the coil and enhance the overall performance.

### SUMMARY OF THE INVENTION

In view of the foregoing, the invention is to provide a magnetic actuator and a magnetic shielding apparatus that has a lower cost and more compact size. This helps reduce the power consumption of the coil and enhance the overall performance.

To achieve the above, the invention discloses a magnetic actuator including a magnetic element, a magnetically conducting element and a coil. The magnetically conducting element is disposed corresponding to the magnetic element. The coil surrounds the magnetically conducting element and rotates with respect to a rotation center.

To achieve the above, the invention also discloses a magnetic light-shielding apparatus including a body, a light-shielding element and a magnetic actuator. The body has a light-penetrating portion. The light-shielding element has one end pivotally disposed on the body to form a rotation center so that the light-shielding element corresponding to the light-penetrating portion rotates with respect to the rotation center. The magnetic actuator has a magnetic element, a magnetically conducting element and a coil. The magnetically conducting element and the magnetic element are disposed on the body in a corresponding way. The coil is disposed on the other end of the light-shielding element and surrounds the magnetically conducting element.

As mentioned above, the magnetic actuator and the magnetic light-shielding apparatus of the invention use only one magnetic element (e.g., a magnet) and have the light-shielding element disposed between the coil and the rotation center. The lever arm of the coil is larger than that of the light-shielding element. In comparison with the prior art, the invention can lower the production cost. Since the magnetic actuator is greatly simplified and the number of involved elements is reduced, the products are more compact and competitive. The coil can rotate the light-shielding element at lower power consumption, improving the overall performance.

### BRIEF DESCRIPTION OF THE DRAWINGS

The invention will become more fully understood from the detailed description given herein below illustration only, and thus is not limitative of the present invention, and wherein:

FIG. 1 is a schematic illustration of the conventional magnetic actuator;

FIG. 2 is a top view of the magnetic actuator in FIG. 1;

FIG. 3 is a schematic illustration of the magnetic light-shielding apparatus according to an embodiment of the invention; and

FIGS. 4 and 5 are schematic views of the disclosed magnetic light-shielding apparatus with different shapes of magnetic elements and/or magnetically conducting element.

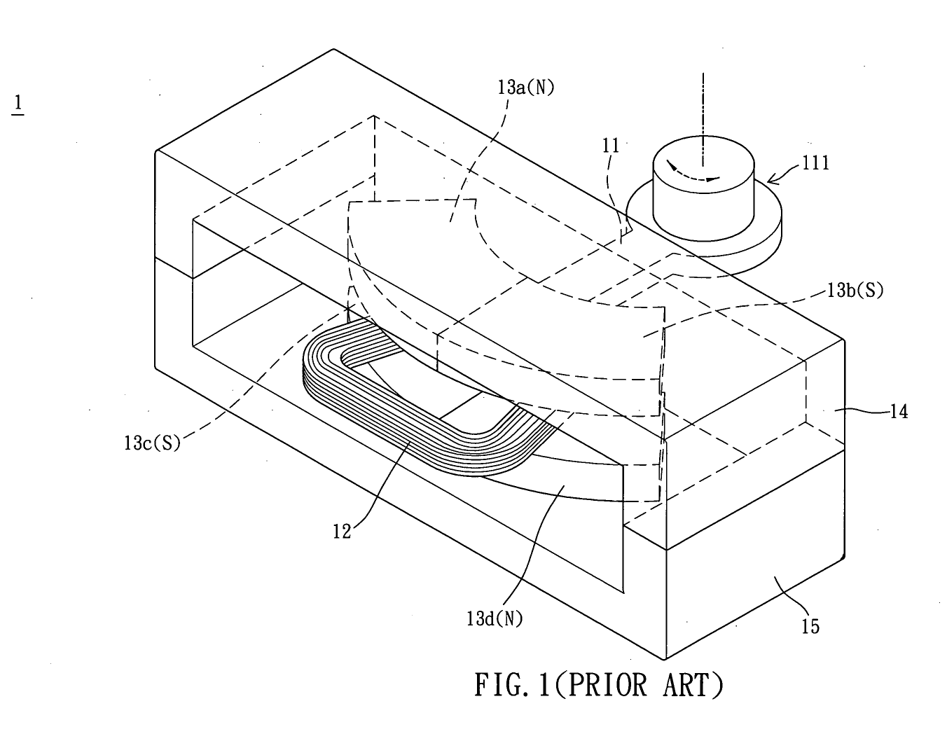

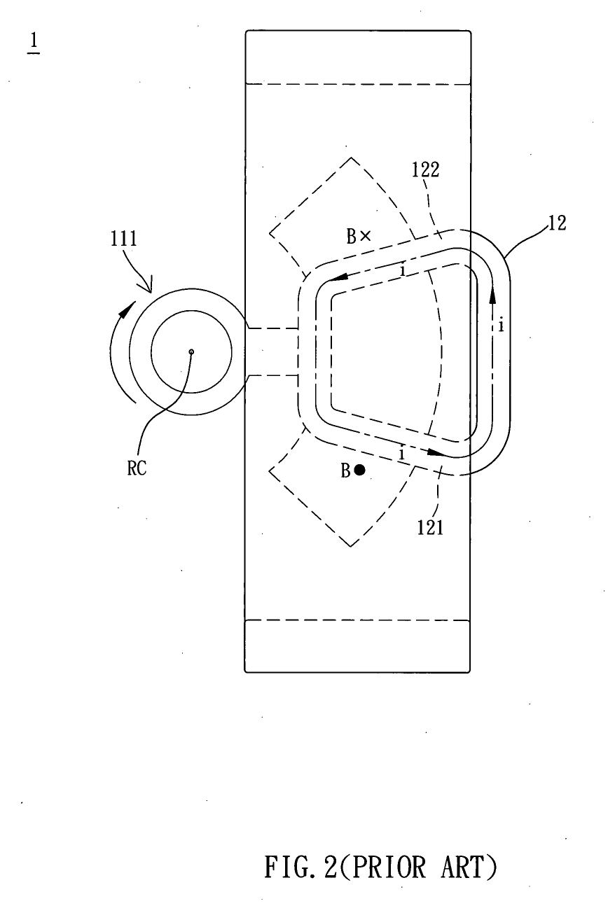

### DETAILED DESCRIPTION OF THE INVENTION

The present invention will be apparent from the following detailed description, which proceeds with reference to the accompanying drawings, wherein the same references relate to the same elements.

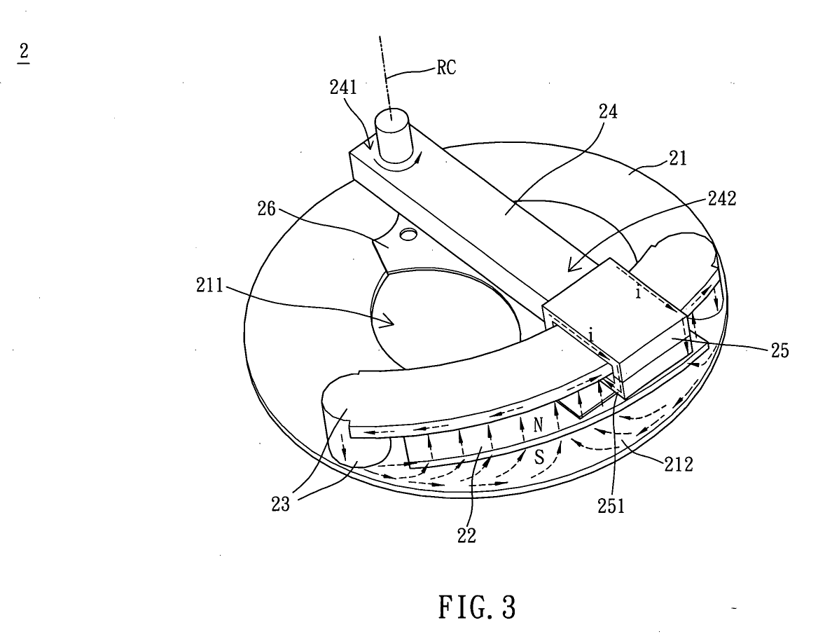

As shown in FIG. 3, a magnetic light-shielding device 2 according to an embodiment of the invention includes a body 21, a magnetic element 22, a magnetically conducting element 23, a light-shielding element 24 and a coil 25. The magnetic element 22, the magnetically conducting element 23, and the coil 25 form a magnetic actuator. The magnetic light-shielding apparatus 2 functions as an iris diaphragm. It is used in a projector, such as a front projector or a rear projector.

The body 21 is a thin sheet and has a light-penetrating portion 211. The light-penetrating portion 211 can be a through hole or made of a transparent material. The magnetic element 22 is disposed on the body 21, also in the shape of a thin sheet. It can be a permanent magnet, an electromagnetic magnet or a magnet. The magnetic element 23 is disposed on the body 21 corresponding to the magnet element 22 and has a U shape. In addition, the magnetically conducting element 23 can be cold-rolled steel, a silicon steel, a yoke or a zinc-coated steel. One end 241 of the light-shielding element 24 is pivotally disposed on the body 21 to form a rotation center RC. The light-shielding element 24 corresponding to the light-penetrating portion 211 rotates with respect to the rotation center RC. According to needs, the shape of the light-shielding element 24 can be designed to be a polygon, an arc or some other shape that can change the incoming optical flux. Alternatively, the light-shielding element 24 can be coupled to a light-shielding plate 26 to control the incoming optical flux. The coil 25 is disposed on the other end 242 of the light-shielding element 24 and surrounds the magnetically conducting element 23. The coil 25 in this embodiment can be the square coil for the convenience of coil winding. However, the shape of the coil 25 is certainly not limited to this example. It can be changed according to needs.

In this embodiment, the body 21 can be magnetically conductive or have a magnetically conducting part 212 in the region corresponding to the magnetically conducting element 23 and the magnetic element 22. In this case, the magnetically conducting part 212, the magnetically conducting element 23, and the magnetic element 22 form a complete magnetic loop (FIG. 3). Of course, if the body 21 is not magnetically conducting, the magnetically conducting element 23 and the magnetic element 22 can form a complete magnetic loop via air or some other medium. In addition, the magnetic element 22 of the embodiment is magnetic in the vertical direction. The side of the magnetic element 22 near the magnetically conducting element 23 is the N pole, and the side near the body 21 is the S pole.

When an electrical current i flows through the coil 25 (in the direction indicated by the arrow), the coil 25 interacts with the passing magnetic lines. For a bottom side 251 of the coil 25 (between the magnetic element 22 and the magnetically conducting element 23), the magnetic lines go from the magnetic element 22 to the magnetically conducting element 23. According to Fleming's right-hand rule, the bottom side 251 of the coil 25 produces a Lorentz force so that the coil 25 rotates with respect to the rotation center RC (in the direction shown in FIG. 3). The light-shielding element 24 is thus driven to control the incoming optical flux through the light-penetrating portion 211.

Alternatively, the polarities of the magnetic element 22 can be reversed. That is, the side of the magnetic element 22 near the magnetically conducting element 23 is the S pole, and the side near the body 21 is the N pole. In this case, to maintain the original rotation direction, one simply reverse the direction of the electrical current i of the coil 25.

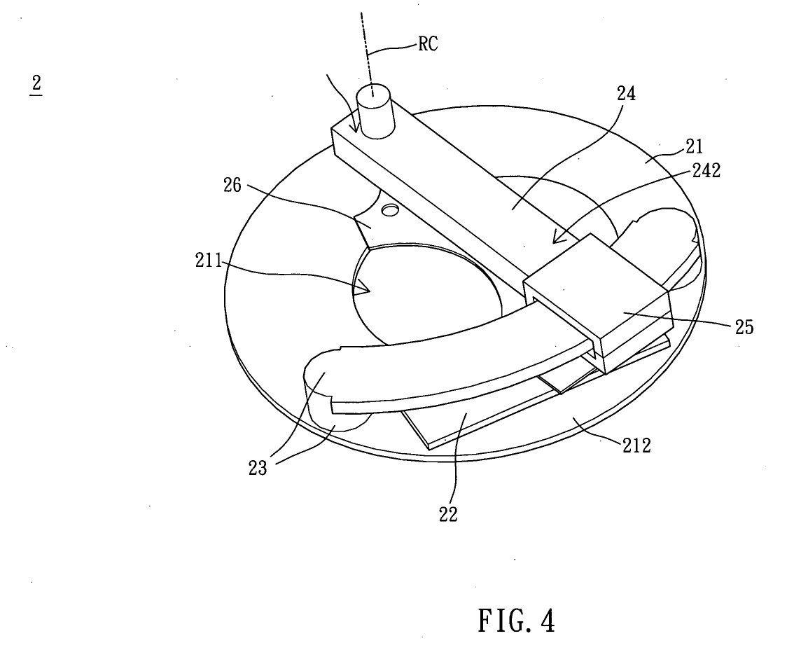

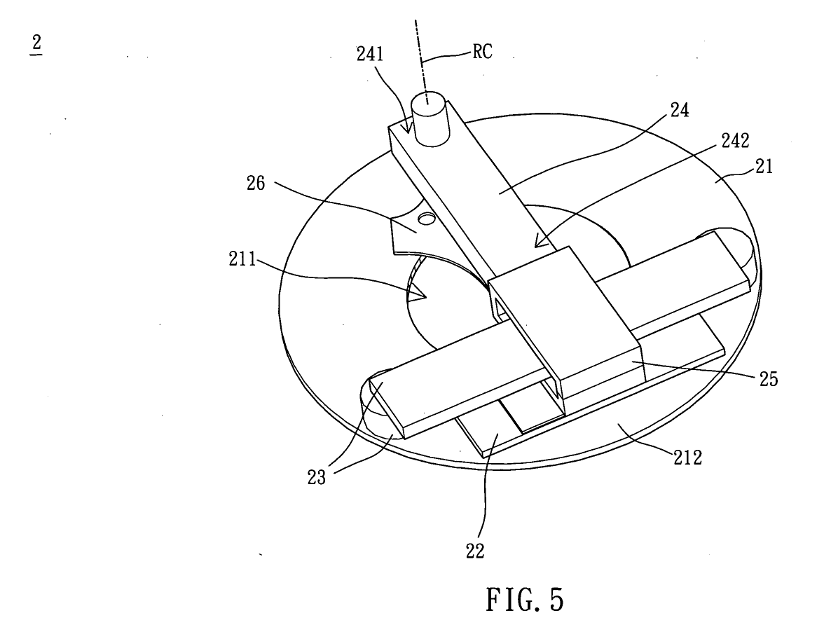

In addition, the magnetic element 22 and/or the magnetically conducting element 23 can have an arc shape (FIG. 3) or a strip-like shape (FIGS. 4 and 5). Nevertheless, such shape variations of the magnetic element 22 and/or the magnetically conducting element 23 are simply examples of the invention.

In summary, the magnetic actuator and the magnetic light-shielding apparatus of the invention use only one magnetic element (e.g., a magnet) and have the light-shielding element disposed between the coil and the rotation center. The lever arm of the coil is larger than that of the light-shielding element. In comparison with the prior art, the invention can lower the production cost. Since the magnetic actuator is greatly simplified and the number of involved elements is reduced, the products are more compact and competitive. The coil can rotate the light-shielding element at lower power consumption, improving the overall performance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A magnetic actuator comprising:
a magnetic element;
a magnetically conducting element disposed corresponding to the magnetic element; and
a coil surrounding the magnetically conducting element and rotating with respect to a rotation center.

2. The magnetic actuator of claim 1, wherein the magnetically conducting element and the magnetic element form a closed magnetic loop.

3. The magnetic actuator of claim 1, wherein the magnetic element has poles in the vertical direction.

4. The magnetic actuator of claim 1, wherein the magnetic element is a permanent magnet, an electromagnetic magnet or a magnet.

5. The magnetic actuator of claim 1, wherein the magnetic element and/or the magnetically conducting element has an arc or strip-like shape.

6. The magnetic actuator of claim 1, wherein the magnetically conducting element is made of a cold-rolled steel, a silicon steel, a yoke or a zinc-coated steel.

7. The magnetic actuator of claim 1, wherein the magnetic actuator is an iris diaphragm actuator.

8. A magnetic light-shielding apparatus comprising:
a body having a light-penetrating portion;
a light-shielding element having one end pivotally disposed on the body to form a rotation center so that the light-shielding element rotates corresponding to the light-penetrating portion with respect to the rotation center; and
a magnetic actuator having a magnetic element, a magnetically conducting element and a coil, wherein the magnetically conducting element and the magnetic element are correspondingly disposed on the body and the coil is disposed on the other end of the light-shielding element and surrounds the magnetically conducting element.

9. The magnetic light-shielding apparatus of claim 8, wherein the magnetically conducting element and the magnetic element form a closed magnetic loop.

10. The magnetic light-shielding apparatus of claim 8, wherein the body is magnetically conductive.

11. The magnetic light-shielding apparatus of claim 10, wherein the body, the magnetically conducting element and the magnetic element form a closed magnetic loop.

12. The magnetic light-shielding apparatus of claim 8, wherein the body is not magnetically conductive, and the magnetically conducting element and the magnetic element form a closed magnetic loop via air or a medium.

13. The magnetic light-shielding apparatus of claim 8, wherein the magnetic element has poles in the vertical direction.

14. The magnetic light-shielding apparatus of claim 13, wherein the magnetic element has an N pole on the side near the magnetically conducting element and an S pole on the side near the body, or the magnetic element has an S pole on the side near the magnetically conducting element and an N pole on the side near the body.

15. The magnetic light-shielding apparatus of claim 8, wherein the magnetic element is a permanent magnet, an electromagnetic magnet or a magnet.

16. The magnetic light-shielding apparatus of claim 8, wherein the magnetic element and/or the magnetically conducting element has an arc or strip-like shape.

17. The magnetic light-shielding apparatus of claim 8, wherein the magnetically conducting element is made of cold-rolled steel, a silicon steel, a yoke or a zinc-coated steel.

18. The magnetic light-shielding apparatus of claim 8, wherein the magnetic actuator is an iris diaphragm.

19. The magnetic light-shielding apparatus of claim 8, wherein the light-shielding element is coupled to a light-shielding plate to control the incoming optical flux.

20. The magnetic light-shielding apparatus of claim 8, wherein the light-penetrating portion is a through hole or made of a transparent material.
